(19) United States
(12) Patent Application Publication
(10) Pub. No.: US 2009/0328100 A1
(43) Pub. Date: Dec. 31, 2009

(54) PROGRAM INFORMATION DISPLAY APPARATUS AND PROGRAM INFORMATION DISPLAY METHOD

(75) Inventor: Takeo Horiguchi, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/495,272

(22) Filed: Jun. 30, 2009

(30) Foreign Application Priority Data
Jun. 30, 2008 (JP) 2008-171599

(51) Int. Cl. H04N 5/445

(52) U.S. Cl. 725/39

(57) ABSTRACT

According to one embodiment, a program information display apparatus includes a signal processing module which acquires program information which announces contents of a scheduled program from a broadcast signal to output the program information for display, and a magnetic disk drive which accumulates the program information acquired by the processing module. The signal processing module analyzes the broadcast signal with respect to a common content characteristic which can identify program information. When it is confirmed as the analysis result that the program information is identified, program information related to at least a program name and broadcasting date and time is detected from the program information. The program attribute is accumulated in the magnetic disk drive in association with the program information.

### CROSS-REFERENCE TO RELATED APPLICATIONS

This application is based upon and claims the benefit of priority from Japanese Patent Application No. 2008-171599, filed Jun. 30, 2008, the entire contents of which are incorporated herein by reference.

### BACKGROUND

1. Field

An embodiment of the invention relates to a program information display apparatus and a program information display method which collect and display program information which announces the contents of scheduled programs.

2. Description of the Related Art

In recent years, in digital television broadcasting, an electronic program guide (EPG) is provided. This electronic program guide introduces a program name, scheduled date and time, a broadcast station, performers, and program contents of a scheduled program with characters or a still image. A user of a digital television receiver uses the electronic program guide to search for a program desired to be viewed, to record the program, or to reserve viewing.

A broadcast station frequently broadcasts a main story of a program or a sponsor commercial message mixed with a video image of a trailer, a program propaganda, or the like. For example, for a serial drama, immediately after a main story is actually broadcast, a video image obtained by organizing a drama scheduled062609 to be broadcast next into a sketch for 30 seconds to about 1 minute is frequently added.

A conventional technique which acquires a video clip for a trailer or a program propaganda from the Internet or a broadcast signal and stores the video clip in relation to a program is known (for example, see Jpn. Pat. Appln. KOKAI Publication No. 2006-191348). In this technique, a video clip can be acquired by specification setting in which the video clip is delivered together with EPG data or a URL (Uniform Resource Locator) representing an address of the video clip on the Internet is incorporated in the EPG data.

However, the above technique cannot cope with a case in which a trailer or a program propaganda is broadcast as a part of, for example, a program video image. The technique requires specification setting to make it possible to acquire a video clip.

### BRIEF DESCRIPTION OF THE SEVERAL VIEWS OF THE DRAWINGS

FIG. 1 is an exemplary diagram schematically showing the circuit configuration of a hybrid video recorder according to an embodiment of the invention;

FIG. 2 is an exemplary view showing a broadcast schedule collecting process performed by a signal processing module shown in FIG. 1;

FIG. 3 is an exemplary view showing a telop character analyzing process performed in a broadcast signal analyzing block shown in FIG. 2;

FIG. 4 is an exemplary view showing a caption analyzing process performed in the broadcast signal analyzing block shown in FIG. 2;

FIG. 5 is an exemplary view showing a data broadcast analyzing process performed in the broadcast signal analyzing block shown in FIG. 2;

FIG. 6 is an exemplary view showing an audio analyzing process performed in the broadcast signal analyzing block shown in FIG. 2;

FIG. 7 is an exemplary view showing a telop image analyzing process performed in the broadcast signal analyzing block shown in FIG. 2;

FIG. 8 is a diagram showing one example of a format of EPG data extracted by the signal processing module shown in FIG. 1;

FIG. 9 is a diagram showing an example of EPG data extracted by the signal processing module shown in FIG. 1;

FIG. 10 is an exemplary view showing a field specification of the EPG data extracted by the signal processing module shown in FIG. 1;

FIG. 11 is a diagram showing an example of an image of an electronic program guide output for display from the signal processing module shown in FIG. 1;

FIG. 12 is an exemplary view showing an image pattern collated in the telop image analyzing process shown in FIG. 7;

FIG. 13 is an exemplary view showing a process to a recording reservation button operation performed by a remote controller shown in FIG. 1; and

FIG. 14 is an exemplary view showing a process to a recording reservation button operation performed by the remote controller shown in FIG. 1 during viewing of a broadcast schedule.

### DETAILED DESCRIPTION

Various embodiments according to the invention will be described hereinafter with reference to the accompanying drawings.

According to one embodiment of the invention, there is provided a program information display apparatus comprising: a processor configured to acquire program information which announces contents of a scheduled program to output the program information for display; a program information storage configured to accumulate the program information acquired by the processor; and a signal storage configured to accumulate a broadcast signal, the processor being configured to analyze the broadcast signal accumulated by the signal storage, detect the program information matched with a program attribute which is obtained as a result of the analysis and includes at least a program name and broadcast scheduled date and time of a scheduled program, and accumulate the accumulated broadcast signal in the program information storage in association with the program information.

According to one embodiment of the invention, there is provided a program information display method for acquiring program information which announces contents of a scheduled program, outputting the program information for display, and accumulating the acquired program information, the method comprising: accumulating and analyzing a broadcast signal; detecting the program information matched with a program attribute which is obtained as a result of the analysis and includes at least a program name and broadcast scheduled date and time of a scheduled program; and accumulating the accumulated broadcast signal in association with the program information.

In the program information display apparatus and the program information display method, the broadcast signal is analyzed, program information matched with a program attribute related to at least the program name and the broadcast scheduled time and date obtained as the analysis result is detected, and the program attribute is accumulated in association with the program information. In this manner, the program information which announces the contents of a scheduled program can be collected in a wide range without requiring special specification setting.

A hybrid video recorder according to an embodiment of the invention will be described below. The hybrid video recorder can function as a program information display apparatus which collects and displays program information which announces the contents of a scheduled program.

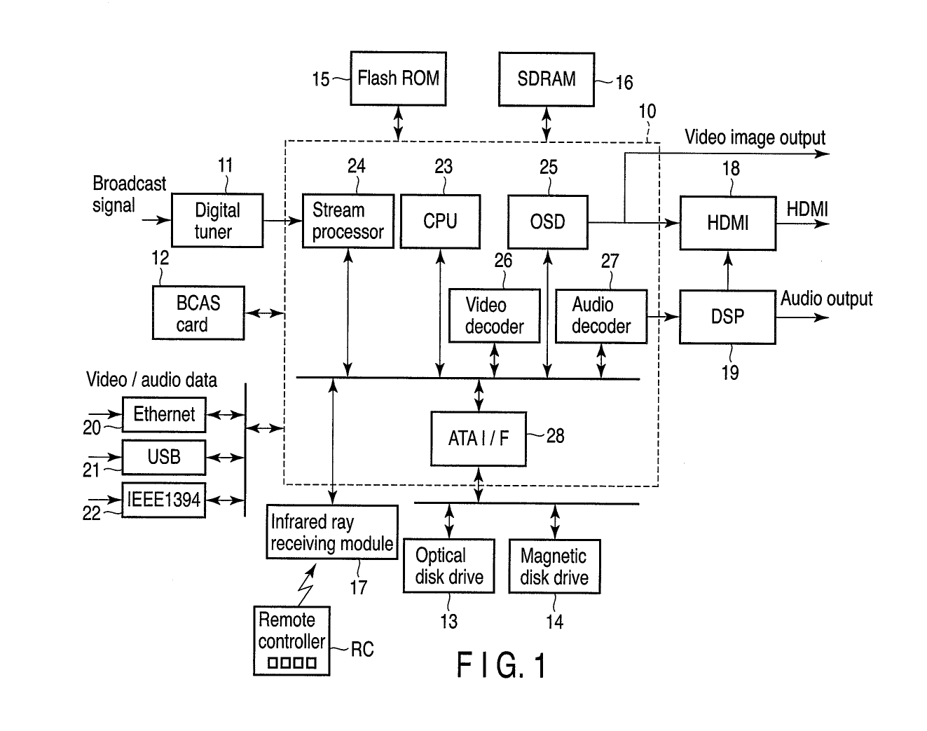

FIG. 1 schematically shows the circuit configuration of the hybrid video decoder. The hybrid video recorder includes a signal processing module 10, a digital tuner 11, a BCAS card slot 12, an optical disk drive 13, a magnetic disk drive (HDD) 14, a flash ROM 15, an SDRAM 16, an infrared ray receiving module 17, an HDMI output module 18, a DSP output module 19, an ethernet (registered trademark) interface 20, a USB interface 21, and an IEEE1394 interface 22.

The digital tuner 11 selects a broadcast station to receive a broadcast signal and demodulates the broadcast signal. The signal processing module 10 acquires a video image and audio of a program from a broadcast signal supplied from the digital tuner 11 and records the video image and the audio on the optical disk drive 13 or the magnetic disk drive 14, or reproduces the video image and the audio from the optical disk drive 13 or the magnetic disk drive 14. The BCAS card slot 12 is connected to the BCAS card to use digital broadcasting. The optical disk drive 13 and the magnetic disk drive 14 mainly store the video image and the audio of a broadcast program as a file. The flash ROM 15 and the SDRAM 16 subsidiary store data for the signal processing module 10. The infrared ray receiving module 17 communicates with a remote controller RC serving as a user interface operated by a user. The HDMI output module 18 and the DSP output module 19 output a video image and audio in digital forms, respectively. The ethernet interface 20, the USB interface 21, and the IEEE1394 interface 22 are used to be linked with external devices, respectively.

The signal processing module 10 includes a CPU 23 which performs various control processes, a stream processor 24 which performs rearrangement of packets to a stream of a broadcast signal demodulated by the digital tuner 11, an OSD 25 which synthesizes a video image obtained by superposing a still image on a moving image, a video decoder 26 which decodes a video signal of a program, an audio decoder 27 which decodes an audio signal of the program, and a serial ATA interface 28 connected to the optical disk drive 13 and the magnetic disk drive 14. These components are interconnected by a bus.

The signal processing module 10 not only performs recording and reproduction of the video image and the audio of the program, but also acquires program information which announces the contents of a scheduled program from a broadcast signal to output the program information for display. The program information acquired by the signal processing module 10 is accumulated in the magnetic disk drive 14 arranged as a memory module. In this case, the signal processing module 10 analyzes a broadcast signal with respect to a common content characteristic which can identify program information. When the signal processing module 10 confirms that the analysis result is program information, the signal processing module 10 detects a program attribute related to at least a program name and broadcast scheduling date and time, and accumulates the program attribute in the magnetic disk drive 14 in association with the program information.

The presence/absence of the common content characteristic is detected from any one of telop characters, a telop image, a caption, data broadcasting, and audio included in a broadcast signal. The above process is realized by the CPU 23 controlled by software.

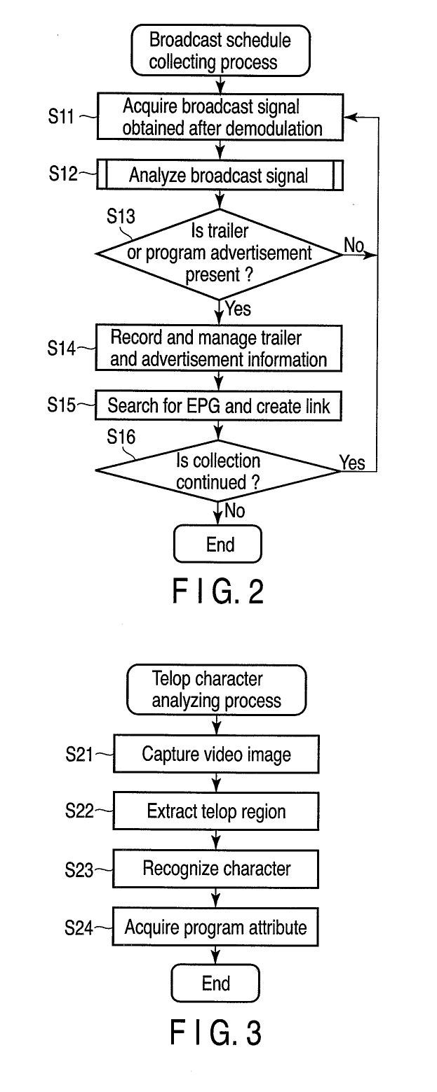

FIG. 2 shows a broadcast schedule collecting process performed by the signal processing module 10. The broadcast schedule collecting process is turned on by setting from the remote controller RC. The broadcast schedule collecting process is a process which analyzes a received broadcast signal to recognize whether the video image is a trailer or a program advertisement, broadcast scheduling date and time, a program name, and the like. When the broadcast schedule collecting process is started, a demodulated broadcast signal is acquired in block S11, and the broadcast signal is analyzed in block S12. When it is detected in block S13 as an analysis result of the broadcast signal that there is program information of the trailer or the program advertisement, recording and management of the program information of the trailer and the advertisement are performed in block S14. More specifically, the magnetic disk drive 14 accumulates the program information. In block S15, an electronic program guide is searched for a program corresponding to the program information, and a link to the program information is created from the program. The program information of the trailer and the advertisement is displayed as a thumbnail at a part of the corresponding program. In block S15, it is checked whether the collection is continued. When the program information of the trailer or the program advertisement is not detected in block S13, and when the collection is continued, the operation returns to block S11. On the other hand, when the broadcast schedule collecting process is set in an OFF state, the process is ended.

FIG. 3 shows a telop character analyzing process performed in block S12 in FIG. 2. When a telop inserted into a video image is recognized, it can be determined that the video image is the trailer or the program advertisement. The telop is normally broadcast while being superposed on a video image, and is not separated as text information. For this reason, when “trailer” and “broadcast is scheduled on x month yth” are displayed on a screen, such contents should be recognized and converted into text information. In block S21, a video signal extracted from a broadcast signal is decoded and captured in units of frames as continuous still images. Subsequently, a telop region in the frame is extracted in block S22. When the telop region is present, coordinates of the region, time at which the telop appears, and image information in which the entire telop region is classified into two types of pixels, i.e., pixels for character information and pixels for non-character information are generated. In the embodiment, the telop is presumed in nature as a part whose pixel position in the video image is kept for a predetermined period of time and which is largely different in brightness, chroma, or the like from the background next to telop characters. On the basis of the image information obtained by classifying the pixels for character and the pixels for non-character, character recognition is performed in block S23 to read characters, and the characters are converted into text information. Furthermore, it is checked in block S24 whether the text information includes a word expressing an attribute of a program, and the word is acquired.

The program attribute means a broadcast date, a broadcasting station, start time, end time, and a program name. The word which is checked to be included in the text information is actually, a “trailer”, a “next week's trailer”, “at this time on the next week”, “x month yth”, “x o'clock y minute, the “x episode”, or the like. The presence/absence of these texts is checked. When these texts appear at about end time of a certain program, the video image can be determined as a trailer video image. Otherwise, it can be determined by a combination of the appeared texts whether the video image is a program advertisement. However, if recording of the video image is started after the determination, an initial part of a trailer is missed in the recorded video image. For this reason, the video image is always recorded on the HDD 14, and the recorded video image is continuously overwritten unless the video image is a trailer video image. As a capacity of the HDD 14 to record a video image, the HDD 14 may have a region in which a video image for about 10 minutes can be recorded. More specifically, if a video image is not determined as a trailer video image within 10 minutes, the video image is overwritten with a new video image. However, when a recording medium such as an HDD is sufficiently secured, a video image may be recorded much longer. Further, if the capacity is large enough, the recorded video image may be permanently saved without being overwritten. To the trailer video image recorded in the manner described above, an identifier (ID) is allocated. In order to associate the trailer video image with program information of a corresponding EPG, on the basis of a word related to a station the program of which is recorded, time, a day of the week, date and time of text information recognized as characters, attribute of recording reservation (whether periodical reservation or not), the corresponding program is determined, and the trailer video image ID of the corresponding program information is stored.

The broadcast schedule collecting process shown in FIG. 2 may be operated only for a predetermined period of time immediately before the end of the program to reduce a processing load, or may be always operated to make it possible to widely detect not only a trailer but also a program advertisement or the like.

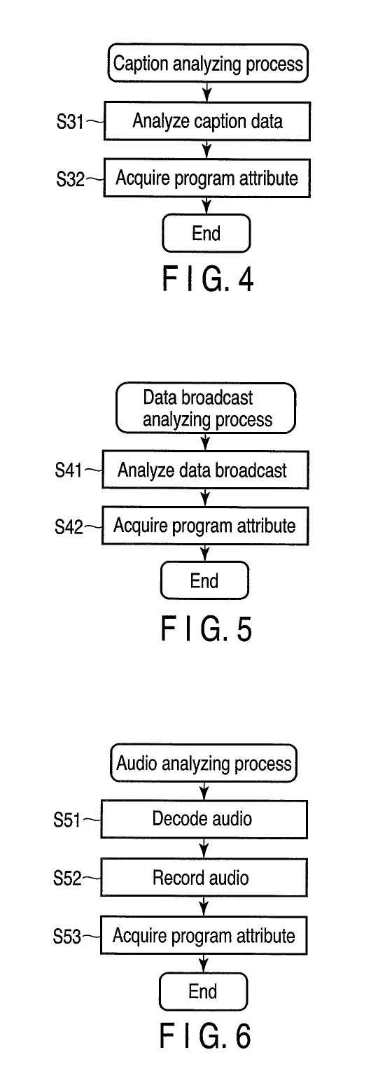

FIG. 4 shows a caption analyzing process performed in block S12 shown in FIG. 2. Caption data is broadcast like a video image or audio. However, since, unlike a telop, text information is directly broadcast, character recognition is not performed. In block S31, it is analyzed whether caption data is present. It is checked in block S32 whether the caption data includes a word expressing an attribute of a program, and the word is acquired.

FIG. 5 shows an data broadcast analyzing process performed in block S12 shown in FIG. 2. Since data broadcasting is performed in a BML (Broadcast Markup Language) format, a parse process is applied to broadcast data to perform analysis in block S41. In block S42, it is determined whether the processed data includes a word expressing a program attribute, and the word is acquired.

FIG. 6 shows an audio analyzing process performed in block S12 shown in FIG. 2. In this process, an audio signal is decoded in block S51, and audio recognizing process is performed in block S52 to convert the audio signal into text information. In block S53, it is determined whether the text information includes a word expressing a program attribute, and the word is acquired.

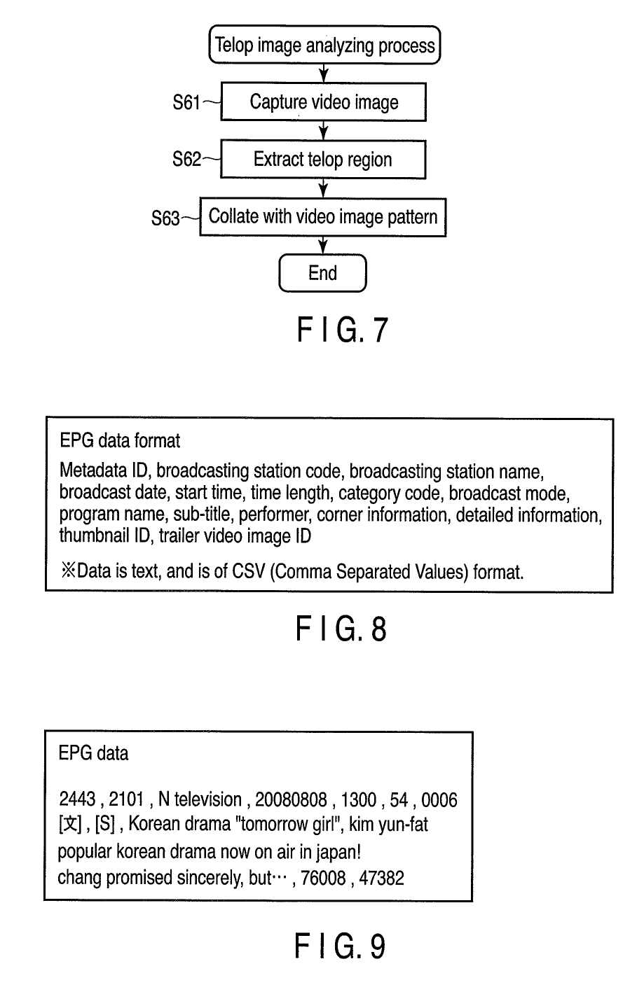

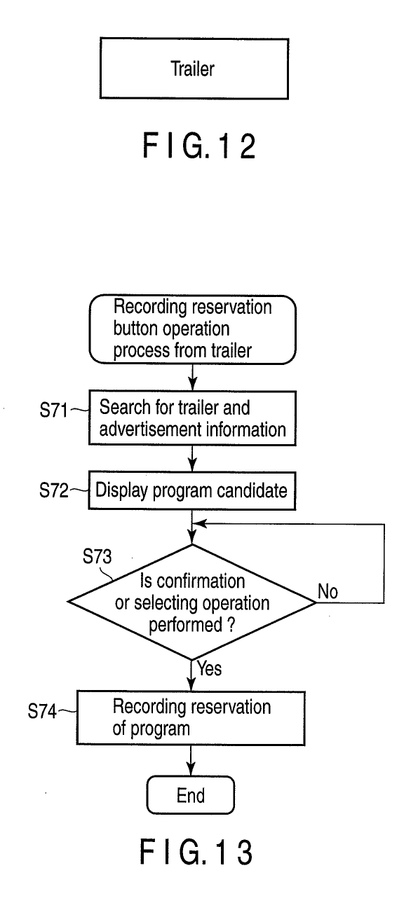

FIG. 7 shows a telop image analyzing process performed in block S12 shown in FIG. 2. In this process, the same video image capture as that in the process in FIG. 3 is performed in block S61, and a telop region is extracted in block S62. In the subsequent block S63, in place of character recognition, collation is performed with an image pattern given as shown in FIG. 12. When the video image is matched with the image pattern, the video image is determined as a trailer video image. However, under only this condition, even though it is known that the video image is a trailer video image, a corresponding program cannot be specified. Therefore, when a reservation attribute of the program is every-week reservation or every-day reservation to make it possible to specify next broadcast scheduled date and time, the corresponding program is specified by the next broadcast scheduled date and time.

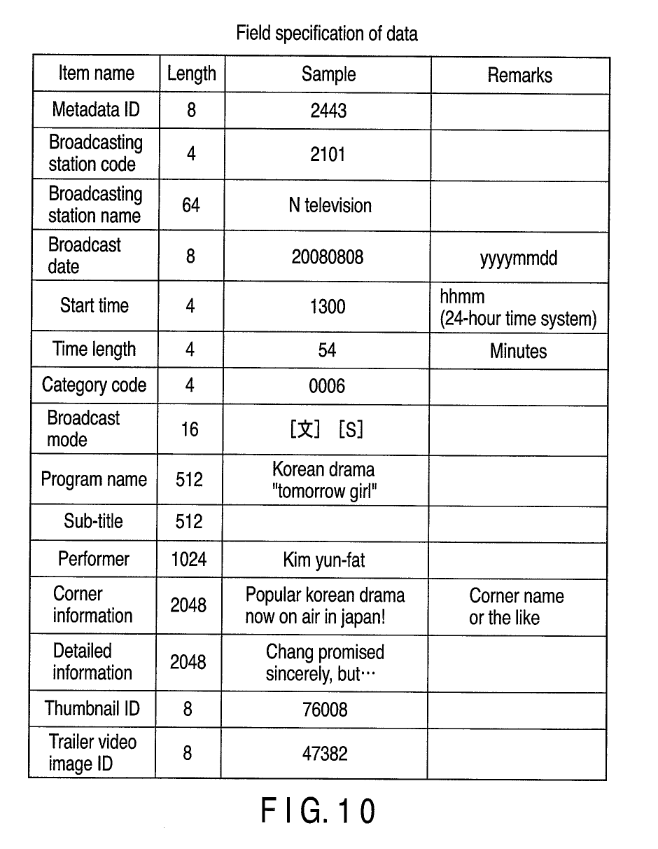

FIG. 8 shows an example of a format of EPG data extracted by the signal processing module 10, FIG. 9 shows an example of the EPG data extracted by the signal processing module 10, and FIG. 10 shows a field specification of the EPG data extracted by the signal processing module 10.

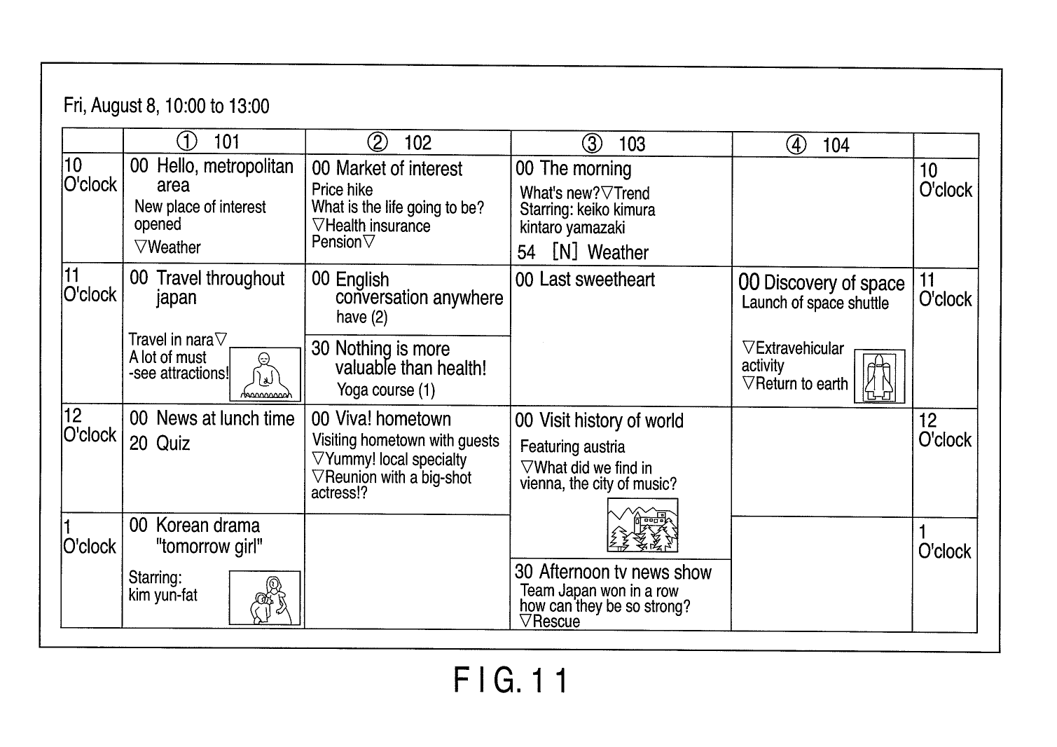

FIG. 11 is a diagram showing, as an example, an image of an electronic program guide output for display from the signal processing module 10. The signal processing module 10 adds a thumbnail of program information which announces the contents of a scheduled program to a program specified by a program attribute on the electronic program guide output for display. When a thumbnail is designated by an operation of the remote controller RC, the program information of the thumbnail is output for display. The electronic program guide is displayed in such a format that time is plotted on the ordinate, and broadcasting stations (channels) are plotted on the abscissa. In this example, date and time displayed at the upper left corner expresses date and time of a program guide displayed at present. When trailer video images or program advertisements are recorded and linked to the EPG data, thumbnails are displayed in several program fields as shown in FIG. 11. The trailer video image can be viewed by setting a cursor pointer and depressing a determination button as operations of the remote controller RC.

FIG. 13 shows a process to a recording reservation button operation performed by the remote controller RC. When a recording reservation or a viewing reservation of a program corresponding to a trailer or an advertisement is performed by an instruction of a user while or after a trailer video image or a program advertisement is displayed, recording reservation can be performed without jotting or memorizing broadcast scheduled date and time and a program name when the program advertisement is viewed. For example, when a recording reservation operation is made by the remote controller RC, the signal processing module 10 searches the HDD 14 for program information of a program broadcast for a predetermined period of time immediately before the reservation operation in block S71, displays a program candidate obtained as a search result in block S72, and it is checked in block S73 whether a confirmation or selecting operation is present. When any one of the operation is detected, reservation is executed to a program matched to a program attribute of the program information in block S74.

More specifically, when a user depresses a reservation button, a program corresponding to a trailer video image or a program advertisement displayed prior to the depression of the button is searched for. A search time range is set to a period of 5 minutes immediately before the button is depressed, for example. When the search time range is lengthened, it is likely that two or more trailer video images or program advertisements have been displayed in the time range. In this case, program information is displayed as a list, and a user selects the program information by an operation of the remote controller RC. Although the selecting operation may cause trouble for the user, if the user understands the video images as a collection of program advertisement video images, the user can find pleasure in selecting the video images. In the list, the video images are sorted in order of date and time of broadcast schedule, order of date and time at which program advertisements are broadcast, order of the number of times of broadcasting of the program advertisements, or the like. Although the above description is performed with respect to only recording reservation, the same processes are performed for viewing reservation.

Note that, as another search method, displayed trailer video images or program advertisements may be searched for a program candidate at time which is closest to the time of depression of the reservation button to perform recording reservation of a corresponding program. Since recording reservation can be executed by only depressing the reservation button, the operation is easy for users.

In the embodiment, a broadcast signal is analyzed with respect to a common content characteristic which can identify program information. When the program information is confirmed as the analysis result, program attributes related to a program name and broadcast scheduled date and time are detected from the program information, and the program attribute is accumulated in a memory module in association with the program information. In this manner, program information which announces the contents of a scheduled program can be collected in a wide range without requiring special specification setting.

This invention is not limited to the embodiment described above and various modifications of the invention can be made without departing from the spirit and scope of the invention.

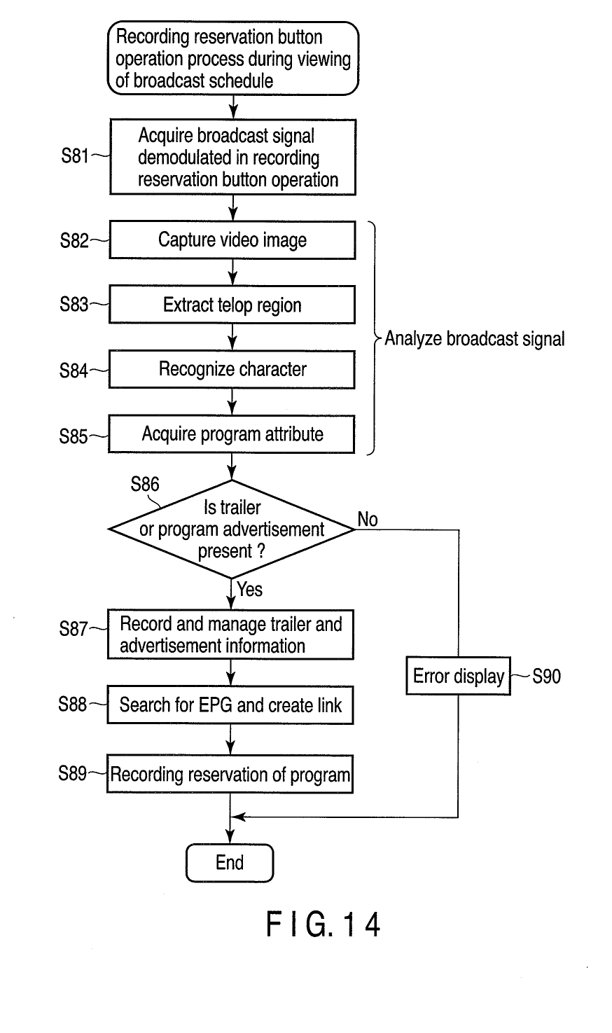

For example, FIG. 14 shows a process to a recording reservation button operation performed with the remote controller RC during viewing of a broadcast schedule. In this process, when a reserving operation for recording is performed with the remote controller RC during broadcasting of program information which announces a program scheduled to be broadcast, the signal processing module 10 acquires the program information from a broadcast signal at the time of a reserving operation in block S81, analyzes the broadcast signal in blocks S82 to S85, and detects and acquires program attributes related to at least a program name and broadcast scheduled date and time from the program information. Thereafter, when it is detected in block S86 that program information of a trailer or a program advertisement is present, recording and management of program information of a trailer and an advertisement is performed in block S87. In block S88, the electronic program guide is searched for a program corresponding to the program information to create a link from the program to the program information. Thereafter, reservation is executed to a program matched with a program attribute in block S89. When program information of a trailer or a program advertisement is not found in block S86, error display is performed in block S90, and the process is ended.

More specifically, while a trailer video image or a program advertisement is displayed, the above process captures an image by designation of a user and recognizes a telop, and recording reservation or viewing reservation of a program corresponding to the trailer or the advertisement is performed. In this process, only a still image obtained at the moment a user makes a designation is captured, and telop recognition is performed. For this reason, a telop recognizing process need not always be performed, and a process load can be reduced.

Furthermore, as another modification, a process of transmitting information of a program corresponding to a trailer or an advertisement to another device may be added. When the invention is applied to, for example, a cellular phone, a user may find a trailer video image or a program advertisement when the user views a program by using a television viewing function of the cellular phone and transfer the corresponding program information to a recorder in her/his house for recording reservation.

Even though only program information consisting of only character information can be acquired from EPG data, a thumbnail can be displayed in a program field of the electronic program guide as described above, and the contents of the program can be visually displayed. A user can perform recording reservation of a corresponding program at a single touch when the user views a trailer video image or a program advertisement, making things easier for the user. The thumbnail can be replaced with a still image or a moving image.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A program information display apparatus comprising:
a processor configured to acquire program information indicative of contents of a program and to output the program information for display; and
a storage module comprising:
a program information storage module configured to store the program information acquired by the processor, and
a signal storage module configured to store a broadcasted signal,
wherein the processor is configured to analyze the broadcast signal stored by the signal storage module, to detect the program information matched with a program attribute obtained as a result of the analysis comprises at least a program name and broadcast date and time of the program, and to store the store broadcast signal in the storage module associated with the program information.

2. The program information display apparatus of claim 1, wherein the processor is configured to detect the program attribute of the program from at least one of a caption character string, a caption image, a caption data, broadcast data, and audio in the broadcast signal.

3. The program information display apparatus of claim 1, wherein the processor is configured to output a thumbnail extracted from the broadcast signal when the processor outputs an electronic program guide for display, the thumbnail being associated with a program identified by the program attribute on the electronic program guide.

4. The program information display apparatus of claim 1,
wherein the processor is configured to search the program information storage for a program attribute of the program obtained by analyzing the broadcast signal within a predetermined time range before and after an receipt of a scheduling command through a user interface, and to schedule playing back and/or recording a program obtained as the search result.

5. The program information display apparatus of claim 1, wherein the processor is configured to analyze the broadcast signal at the time of receiving a scheduling command through a user interface, to detect a program attribute obtained as a result of the analysis comprising at least a program name and broadcast date and time of the program, and to schedule recording and/or playing back the program comprising the program attribute matched with a program attribute of a program requested by the scheduling command.

6. A program information display method for acquiring program information indicative of contents of a program, outputting the program information for display, and storing the acquired program information, the method comprising:
storing and analyzing a broadcast signal;
detecting the program information matched with a program attribute which is obtained as a result of the analysis comprising at least a program name and broadcast date and time of the program; and
storing the stored broadcast signal in association with the program information.

7. The program information display method of claim 6, wherein the program attribute of the program is detected from at least one of a caption character string, a caption image, a caption data, broadcast data, and audio in the broadcast signal.

8. The program information display method of claim 6, further comprising:
outputting a thumbnail extracted from the broadcast signal while outputting an electronic program guide for display, the thumbnail being associated with a program identified by the program attribute on the electronic program guide.

9. The program information display method of claim 6, further comprising:
searching a program attribute of the program obtained by analyzing the broadcast signal broadcast within a predetermined time range before and after an receipt of a scheduling command through a user interface; and
scheduling recording and/or playing back the program obtained as the search result.

10. The program information display method of claim 6, wherein the broadcast signal is analyzed at the time of receiving a scheduling command through a user interface, a program attribute obtained as a result of the analysis comprising at least a program name and broadcast date and time of the program is detected, and recording and/or playing back is scheduled to the program comprising the program attribute matched with a program attribute of a program requested by the scheduling command.
